(19) United States
(12) Patent Application Publication
(10) Pub. No.: US 2015/0016878 A1
(43) Pub. Date: Jan. 15, 2015

(54) QUICK CONNECT SYSTEM FOR TRACTOR STEERING WHEELS INCLUDING STEERING WHEELS EQUIPPED WITH AUTO-STEER MOTORS

(71) Applicant: John D. Isaacson, Dundas, MN (US)

(72) Inventor: John D. Isaacson, Dundas, MN (US)

(21) Appl. No.: 14/329,898

(22) Filed: Jul. 12, 2014

Related U.S. Application Data
(60) Provisional application No. 61/845,583, filed on Jul. 12, 2013.

(51) Int. Cl. B62D 1/10; F16D 1/033

(52) U.S. Cl. CPC B62D 1/10; F16D 1/033
USPC 403/327; 403/374.2

(57) ABSTRACT

A quick connect system for a vehicle steering wheel system includes a sleeve concentrically received around a steering shaft of the vehicle and a hub concentrically received around and releasably secured to the sleeve by at least one fastener. Mating non-rotary interfaces are provided between the shaft and sleeve and the hub and the sleeve when the shaft, sleeve and hub are concentrically arranged relative to one another. The hub is releasably secured to by a plurality of fasteners to a rotatable output member of an auto-steer motor of the steering wheel system to permit steering wheel systems that include auto-steer motors to be installed on the steering shafts of vehicles not originally equipped with auto-steer motors.

### TECHNICAL FIELD

This invention relates to agricultural implements, such as tractors, combines, self-propelled sprayers, and the like, that are operated by an operator who is carried on the implement and who guides or steers the implement using a rotatable steering wheel that the operator turns from side to side to initiate steering actions. More particularly, this invention relates to a system for quickly connecting such a steering wheel to a steering shaft to which the steering wheel is connected to permit replacing an OEM steering wheel with an aftermarket steering wheel system including an aftermarket steering wheel system equipped with a GPS controlled auto-steer motor.

### BACKGROUND OF THE INVENTION

Various agricultural implements have traditionally been steered by an operator who manually controls the direction of movement of the implement using a traditional steering wheel or some other type of steering controls, such as left and right control levers. While effective, this requires skill and attention on the part of the operator to steer a straight line when planting, to execute proper turns at the end of each pass, and the like. In turn, this can be fatiguing for an operator to do during a long day of field work. Any steering errors can lead to lost yield or productivity from a farm field, particularly if replanting or the like is required or if overspraying of a fertilizer occurs which decreases yield.

Modern tractors are equipped with GPS systems and automatic steering systems that allow the implement to steer itself using the GPS coordinates of the implement to rectify some of these problems. This allows more precise planting, spraying and similar agricultural operations. However, many existing implements are in use that lack such auto-steer systems. While aftermarket steering systems that include an auto-steer motor and a control system therefor are available for retrofitting such implements, installation of such steering systems is time-consuming and laborious. Thus, it would be an advance in the art to supply a quick connect system that would cut the time and effort required in making such retrofit installations.

### SUMMARY OF THE INVENTION

One aspect of this invention relates to a quick connect system for attaching a steering wheel system comprising a rotatable steering wheel positioned atop an auto-steer motor to a rotatable steering shaft of an agricultural vehicle. The auto-steer motor has a rotatable output member that is rotated when the auto-steer motor is activated by a control system in accordance with geographical positioning of the vehicle. The quick connect system of one embodiment of this invention comprises a sleeve having a central bore that is concentrically and non-rotatably received on an upper end of the steering shaft such that rotation of the sleeve is effective to rotate the steering shaft. The sleeve has at least one groove or relief provided on at least one side thereof. In addition, the quick connect system includes a hub having a central bore that is concentrically and non-rotatably received on the sleeve when the sleeve is non-rotatably received on the upper end of the steering shaft. The hub has at least one fastener passageway in at least one side thereof that is aligned with the at least one groove or relief in the sleeve when the hub is received on the sleeve. The hub is rigidly and releasably affixed to the output member of the auto-steer motor such that rotation of the output member rotates the hub when the auto-steer motor is activated, rotation of the hub in turn rotates the sleeve, and rotation of the sleeve in turn rotates the steering shaft. Finally, the quick connect system further comprises an elongated fastener passing through the at least one fastener passageway in the hub and through the at least one groove or relief in the sleeve to secure the hub to the sleeve in a quick connect manner by installation of the fastener.

Another aspect of this invention relates to a quick connect system for a steering wheel system of a vehicle. The quick connect system comprises a sleeve concentrically received around a steering shaft of the vehicle and a hub concentrically received around and releasably secured to the sleeve by at least one fastener. Mating non-rotary interfaces are provided between the shaft and sleeve and the hub and the sleeve when the shaft, sleeve and hub are concentrically arranged relative to one another. The hub is releasably secured to a rotatable output member of an auto-steer motor of the steering wheel system

### BRIEF DESCRIPTION OF THE DRAWINGS

This invention will be described more specifically in the following Detailed Description, when taken in conjunction with the following drawings, in which like reference numerals refer to like elements throughout.

FIG. 1 is a perspective view of the operator cab of a typical agricultural implement, particularly illustrating a conventional OEM steering wheel atop a steering column prior to the quick connect system of this invention having been used to replace such OEM steering wheel with an aftermarket steering wheel system;

FIG. 2 is a perspective view of the operator cab shown in FIG. 1, but with the OEM steering wheel having been removed from atop the steering column to illustrate the construction of the upper end of the rotatable steering shaft within the steering column;

FIG. 3 is a perspective view of one type aftermarket steering wheel system, such steering wheel being equipped with an underlying auto-steer motor to allow automatic steering of the implement using GPS data;

FIG. 4 is a perspective view of the aftermarket steering wheel system of FIG. 3, particularly illustrating the bolt hole pattern in the rotary output member of the auto-steer motor;

FIG. 5 is a perspective view of one portion of the quick connect system of this invention, particularly illustrating a sleeve that is intended to mount to the upper end of the steering shaft but showing the sleeve in a dismounted configuration;

FIG. 6 is a perspective view of the sleeve of FIG. 5, but showing the sleeve having been mounted to the upper end of the steering shaft of FIG. 2;

FIG. 7 is a perspective view of another portion of the quick connect system of the invention, particularly illustrating a first embodiment of a hub that is intended to mount to the aftermarket steering wheel system of FIG. 3 which hub is thereafter non-rotatably secured to the sleeve of FIG. 5;

FIG. 8 is a side-elevational view of the hub of FIG. 7;

FIGS. 9-11 are perspective views that illustrate the act of installing the aftermarket steering wheel system of FIG. 3 equipped with the hub of FIG. 7 onto the sleeve of FIG. 5 after such sleeve has been installed on the upper end of the rotatable steering shaft of the implement;

FIG. 12 is a perspective view of an extension member secured to the hub of FIG. 7 for use when an aftermarket steering wheel that does not have an underlying steering motor is being mounted on the steering shaft;

FIG. 13 is a perspective view of the extension member of FIG. 12 after such extension member has been coupled to an aftermarket steering wheel without an underlying steering motor;

FIG. 14 is a perspective view showing the extension member and hub of FIG. 7 in place on the implement to thereby couple the aftermarket steering wheel of FIG. 13 to the sleeve of FIG. 5 after such sleeve has been installed on the upper end of the rotatable steering shaft;

FIG. 15 is a perspective view of a second alternative embodiment for the hub of FIG. 7;

FIG. 16 is a perspective view of a third alternative embodiment for the hub of FIG. 7;

FIG. 17 is a perspective view of the upper end of a control shaft for a telescopic extension system for the steering shaft of the implement, the control shaft being concentrically received within the steering shaft of the implement;

FIG. 18 is a perspective view of the disassembled parts of a quick connect extender that may be additionally used with the quick connect system of this invention, the quick connect extender being used to connect to the control shaft to selectively actuate the same to thereby unlock or lock the steering shaft for telescopic extension relative to the operator;

FIG. 19 is a bottom perspective view of the parts of the quick connect extender of FIG. 18, particularly illustrating the parts in an assembled condition with the quick connect extender having been secured to a knob on the steering wheel that locks and unlocks the telescopic extension system of the steering shaft;

FIG. 20 is a side elevational view of the assembled parts of the quick connect extender of FIG. 19, particularly illustrating the knob on the steering wheel;

FIG. 21 is a top plan view of the assembled parts of the quick connect extender of FIG. 19, showing the upper end of the stem of the quick connect extender having been bolted to the knob on the steering wheel;

FIGS. 22 and 23 are side elevational views that show the quick connect extender of FIGS. 18 and 19 being installed on the upper end of the control shaft; and

FIG. 24 is a bottom perspective view of the steering wheel with the auto-steer motor of the aftermarket steering wheel system installed on the bottom of the steering wheel to illustrate how the quick connect extender is recessed inside an interior cavity of the auto-steer motor.

### DETAILED DESCRIPTION

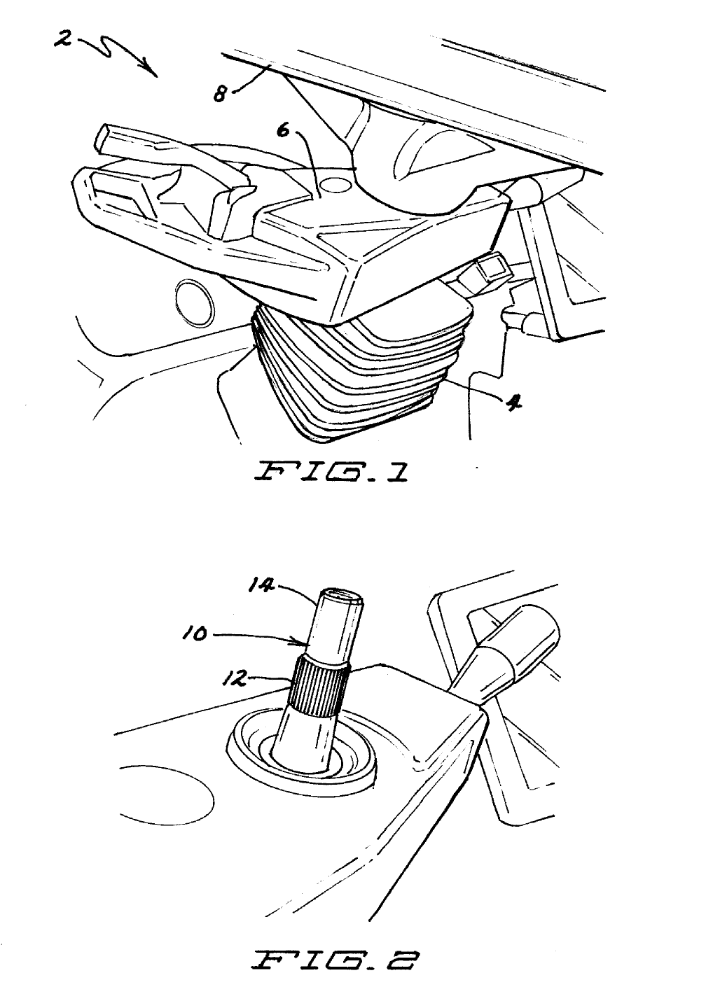

Referring first to FIG. 1, a portion of the operator's cab of a typical agricultural implement is shown generally as 2. Cab 2 includes an upwardly extending steering column comprising a tilt section 4 allowing the angle of the steering column to be adjusted to the operator's preference, a control console 6 having various operational controls and levers for access by the operator, and a rotatable steering wheel 8 that can be gripped and rotated by the operator who is sitting on a seat (not shown) within cab 2. Steering wheel 8 depicted in FIG. 1 is the steering wheel that was supplied by the OEM manufacturer of the implement and will be hereafter referred to as OEM steering wheel 8. Rotation of OEM steering wheel 8 is transmitted through the steering system of the implement to cause the implement to steer to the left or right depending on whether OEM steering wheel 8 is rotated to the left or right, respectively. The portion of the steering system that is directly connected to OEM steering wheel 8 is a generally vertically extending rotatable steering shaft 10 that extends upwardly through the steering column.

FIG. 2 illustrates the upper end of steering shaft 10 of the implement since OEM steering wheel 8 has been removed therefrom. The upper end of rotatable steering shaft 10 comprises a first vertically extending splined section 12 extending around the circumference of the outer diameter of the upper end of the rotatable shaft. A second horizontally threaded section 14 is placed atop and immediately adjacent to splined section 12. Threaded section 14 forms the termination of the upper end of steering shaft 10.

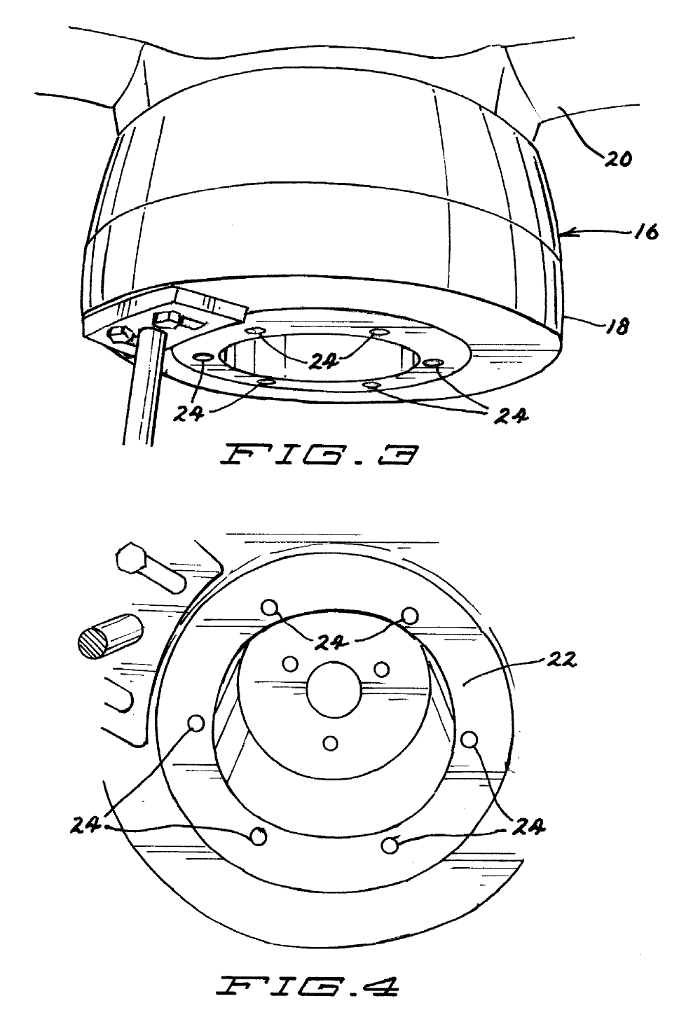

Referring now to FIGS. 3 and 4, an aftermarket steering wheel system known as the EZ-Pilot™ manufactured and sold by Trimble Navigation Limited is illustrated generally as 16. Aftermarket steering wheel system 16 includes an electric auto-steer motor indicated generally as 18. A fairly conventional steering wheel 20 sits atop auto-steer motor 18. System 16 includes a controller (not shown) that feeds GPS data to auto-steer motor 18 to allow auto-steer motor 18 to automatically steer the implement in accordance with GPS data when the auto-steer steer feature is engaged. When the auto-steer feature is disengaged, steering wheel 20 permits unrestricted manual steering by the operator. Steering wheel 20 can be newly supplied as part of system 16 by the aftermarket supplier or the OEM steering wheel 8 could be used as steering wheel 20 if system 16 were designed to permit such use.

Referring now to FIG. 4, auto-steer motor 18 of aftermarket steering wheel system 16 has a rotatable output member in the form of a drive ring 22 that is rotated when auto-steer motor 18 is activated. Drive ring 22 has a plurality of internally threaded bolt holes 24 circumferentially spaced around the diameter of drive ring 22 at fairly equal intervals. Bolt holes 24 receive machine bolts 26 as will be explained hereafter (See FIG. 10). There are six such bolt holes 24 and six such bolts 26, though the number of bolt holes 24 and bolts 26 could obviously be varied.

This invention relates to a quick connect system, generally indicated as 30 in FIG. 10, that is adapted to allow OEM steering wheel 8 of the implement to be removed from steering shaft 10 and replaced with aftermarket steering wheel system 16 of FIGS. 3 and 4. There are three primary components of quick connect system 30. The first component is a sleeve 32 that is non-rotatably mounted to the upper end of steering shaft 10. The second component is a hub 34 that is non-rotatably mounted to drive ring 22 of auto-steer motor 18 of aftermarket steering wheel system 16. The third component is one or more fasteners 36 that non-rotatably couple sleeve 32 and hub together. These components will now be described in more detail.

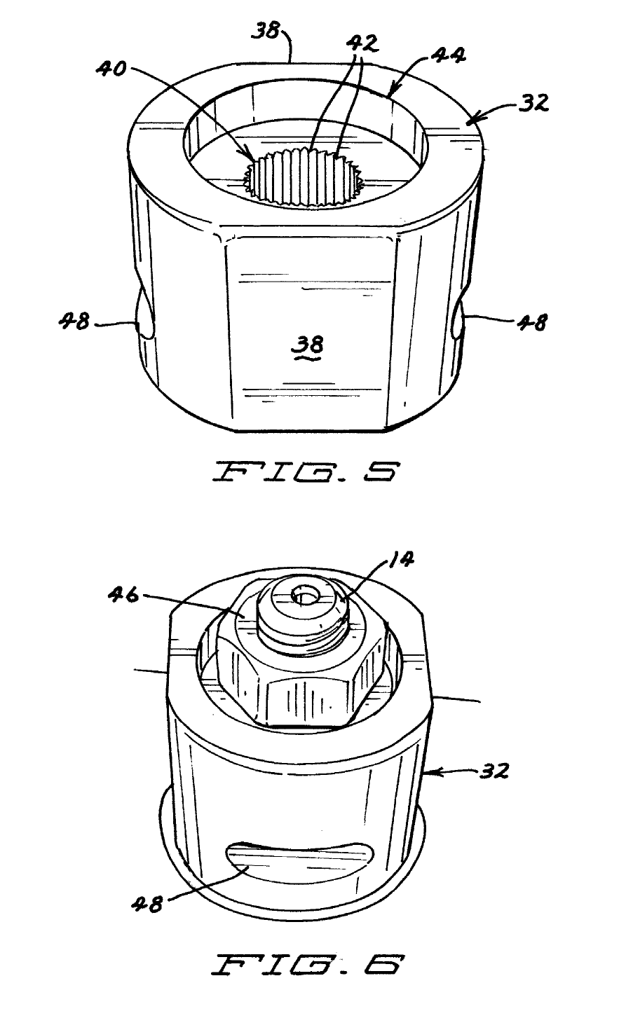

Referring first to FIG. 5, sleeve 32 is a generally, but not entirely, cylindrical member having a fairly uniform diameter. Sleeve 32 is not entirely cylindrical because it is provided with two parallel flats 38 on opposite sides of sleeve 32. Flats 38 give sleeve 32 a non-circular outer circumference. Hub 34, which will be described in more detail hereafter, has a bore with a mating cross-sectional shape, i.e. a mostly circular bore but with the same two parallel flats. This allows hub 34 to be concentrically positioned over sleeve 32 with sleeve 32 and hub 34 being non-rotatably coupled to one another, i.e. rotation of hub 34 will similarly rotate sleeve 32 through the engagement of their respective flats. Sleeve 32 and hub 34 are preferably made of a machined metallic material, such as steel.

Referring further to FIG. 5, sleeve 32 has a central bore 40 that carries a plurality of vertically extending splines 42 along at least a portion of its length. The diameter of bore 40 is slightly larger than the outer diameter of splined section 12 of steering shaft 10 and splines 42 on bore 40 are shaped to fit with the splines on splined section 12 of steering shaft 10 when sleeve 32 is telescopically inserted onto the upper end of steering shaft 10. These inter-engaging splined sections, one on sleeve 32 and the other on the upper end of steering shaft 10, non-rotatably couple sleeve 32 to steering shaft 10, i.e. when sleeve 32 turns it turns steering shaft 10. The upper end of sleeve 32 has an enlarged diameter, smooth bored section 44 that forms a bearing area for the reception of a securing nut 46. After sleeve 32 is telescopically inserted over the upper end of steering shaft 10, nut 46 is tightened onto threaded section 14 of steering shaft 10 to hold sleeve 32 on steering shaft 10.

Sleeve 32 has two horizontal, semi-circular grooves or reliefs 48 located on opposite sides of sleeve 32 with the grooves being displaced by 90° from flats 38. One end of each relief 48 can be seen in FIG. 5. One relief 48 is visible in its entirety in FIG. 6. Reliefs 48 are parallel to one another and positioned at the same height along sleeve 32. Reliefs 48 will receive one side of fasteners 36 that secure sleeve 32 and hub 34 together with such reception preventing disassembly of hub 34 from sleeve 32 when fasteners 36 are installed.

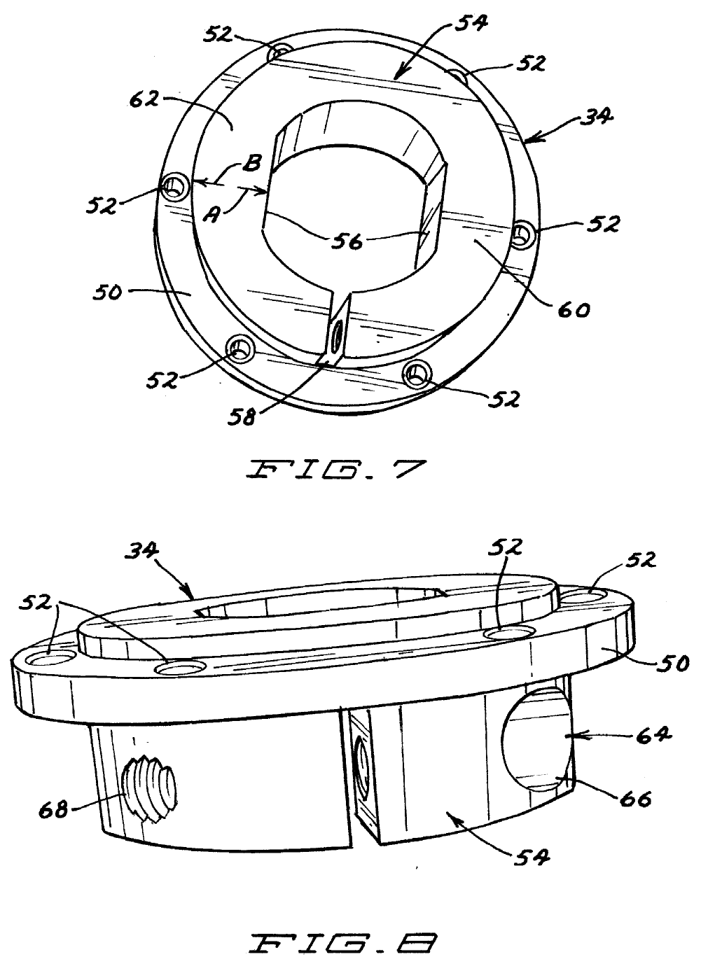

FIGS. 7 and 8 illustrate a first embodiment of hub 34 that will be mounted to the underside of aftermarket steering wheel system 16. Hub 34 comprises an annular mounting ring 50 having six bolt holes 52 therein in the same pattern as the pattern of bolt holes 24 in drive ring 22 of auto-steer motor 18. This allows hub 34 to be rigidly bolted to drive ring 22. Hub 34 further comprises a split collar 54 that is rigidly secured along one side thereof to mounting ring 50. Collar 54 and any portion of mounting ring 50 above collar 54 have internal bores or passages that carry the two flat cross-sectional configuration (see flats 56 on collar 54) that mates with the two flat configuration of the outer diameter of sleeve 32.

Collar 54 is a generally cylindrical collar having a small removed section or split 58 along one side. Collar 54 comprises a first half 60 or so that is rigidly affixed to mounting ring 50. The remaining half 62 of collar 54 is not rigidly affixed to mounting ring 50, but is separated therefrom so that the remaining half of collar 54 can move at least slightly towards or away from the fixed half 60 of collar 54 in the direction of the arrows A and B in FIG. 7. Thus, collar 54 is at least slightly compressible in the nature of a clamp.

Referring now to FIG. 8, collar 54 further includes a horizontal, fastener receiving passageway 64 extending all the way through the side of collar 54 having split 58. Passageway 64 is disposed in two portions on either side of the split 58. The first portion of passageway 64 is an enlarged pocket 66 that will receive the enlarged head 70 of a threaded fastener 36, e.g. a fairly large machine bolt. The second portion of passageway 64 is an internally threaded bore 68 in which the threaded end of the shank of fastener 36 will be tightened by a threading action when fastener 36 is installed. When fastener 36 is installed and tightened, the movable half 62 or so of collar 54 will be drawn towards the fixed half 60 of collar 54 until the head 70 of fastener 36 is received in pocket 66 and abuts against an inner end (not shown) of pocket 66.

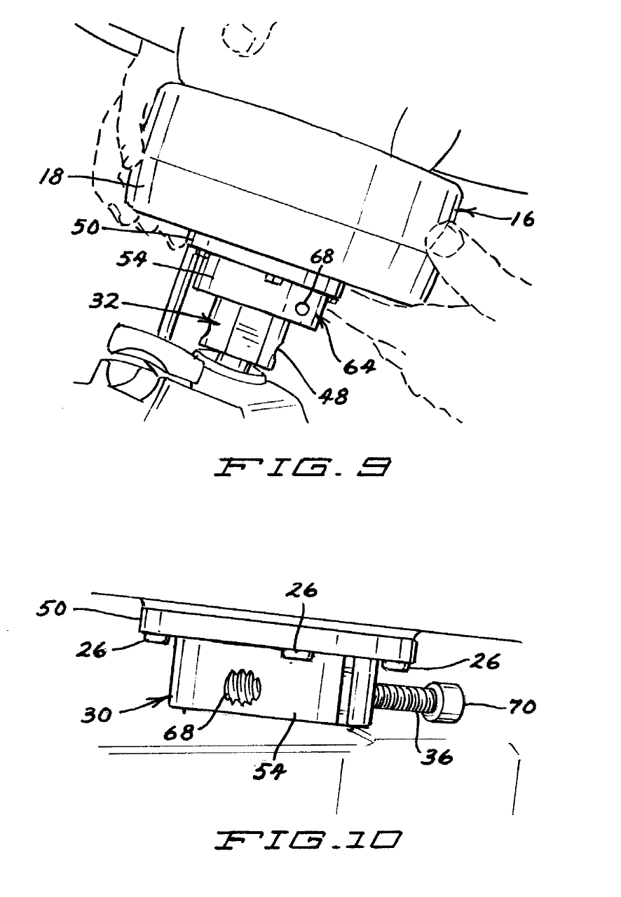

Referring now to FIGS. 9-11, an operator can use quick connect system 30 as follows. Assume first that OEM steering wheel 8 is removed from the upper end of steering shaft 10, that sleeve 32 has been installed on the upper end of steering shaft 10, and that hub 34 has been installed on the bottom of auto-steer motor 18 by bolting mounting ring 50 of hub 34 to drive ring 22 of auto-steer motor 18. After this has been done, the operator can then telescopically insert collar 54 of hub 34 over sleeve 32. The beginning of this action is shown in FIG. 9. This insertion is done by aligning the matching the cross-sectional shapes of hub 34 and sleeve 32 with one another, namely by aligning flats 56 on hub 34 with flats 38 on sleeve 32.

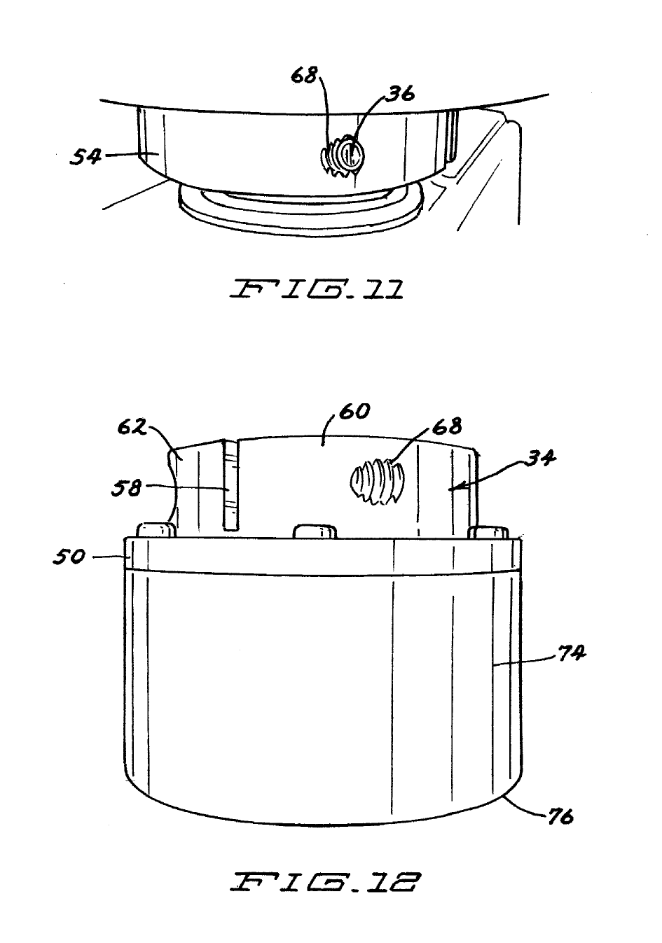

Once hub 34 is dropped down onto sleeve 32 with sleeve 32 passing upwardly through collar 54 and mounting ring 50 of hub 34, passageway 64 in hub 34 will be aligned with one of the reliefs 48 in sleeve 32. As seen in FIG. 10, the operator can then push fastener 36 into pocket 66, along the relief 48 in sleeve 32 with one side of the shank of fastener 36 being received in relief 48, and then far enough so that the threaded free end of the shank of fastener 36 is received in threaded bore 68 of passageway 64. When fastener 36 is tightened, first by hand and then by using an Allen Wrench, fastener 36 will eventually pass substantially all the way through passageway 64 as shown in FIG. 11 with collar 54 of hub 34 slightly compressing to tighten around sleeve 32. In this fully tightened condition, fastener 36 locks sleeve 32 and hub 34 together to ensure the two remain assembled to one another.

When auto-steer motor 18 is active in an auto-steer mode, drive ring 22 will rotate in accordance with GPS data to automatically steer the implement. The rotation of drive ring 22 is securely transmitted to steering shaft 10. This happens because drive ring 22 of auto-steer motor 18 is fixed to hub 34 by mounting ring 50 of hub 34, hub 34 and sleeve 32 are rotatably coupled to one another by the mating two flats in their cross-sectional shapes, and sleeve 32 is rotatably coupled to steering shaft 10 by the inter-engaging splined sections. Thus, quick connect system 30 permits OEM steering wheel 8 to be quickly and easily removed and replaced with an aftermarket steering wheel system 16 having an auto-steer motor 18. This allows a farmer to easily retrofit existing agricultural equipment with auto-steer capability.

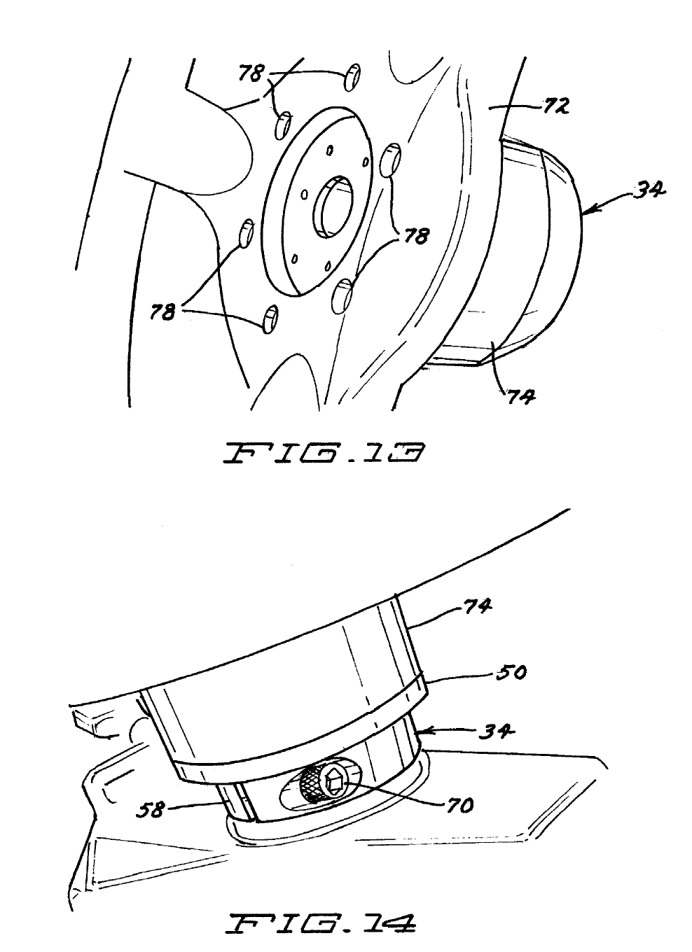

FIGS. 12-14 depict an extension member that allows quick connect system 30 to be used to fit a different type of aftermarket steering wheel to steering shaft 10, i.e. an aftermarket steering wheel 72 that is just a relatively flat steering wheel and does not have an underlying auto-steer motor. The extension member comprises an extension cylinder 74 that may be bolted at one end to mounting ring 50 of hub 34 in the same manner as when mounting ring 50 was bolted to drive ring 22. The opposite end of extension cylinder 74, i.e. the end 76 opposite to the end carrying hub 34, is provided with a plurality of bolt holes (not shown) in a pattern that mates with various bolt holes 78 in the steering wheel 72. Thus, the steering wheel 72 is bolted to the opposite end 76 of extension cylinder 74 as shown in FIG. 13. Hub 34 is then installed on the upper end of steering shaft 10 as described earlier herein and as shown in FIG. 14. Extension cylinder 74 is used to appropriately position or locate steering wheel 72 in the proper vertical position given the fact that the depth of auto-steer motor 18 is no longer present.

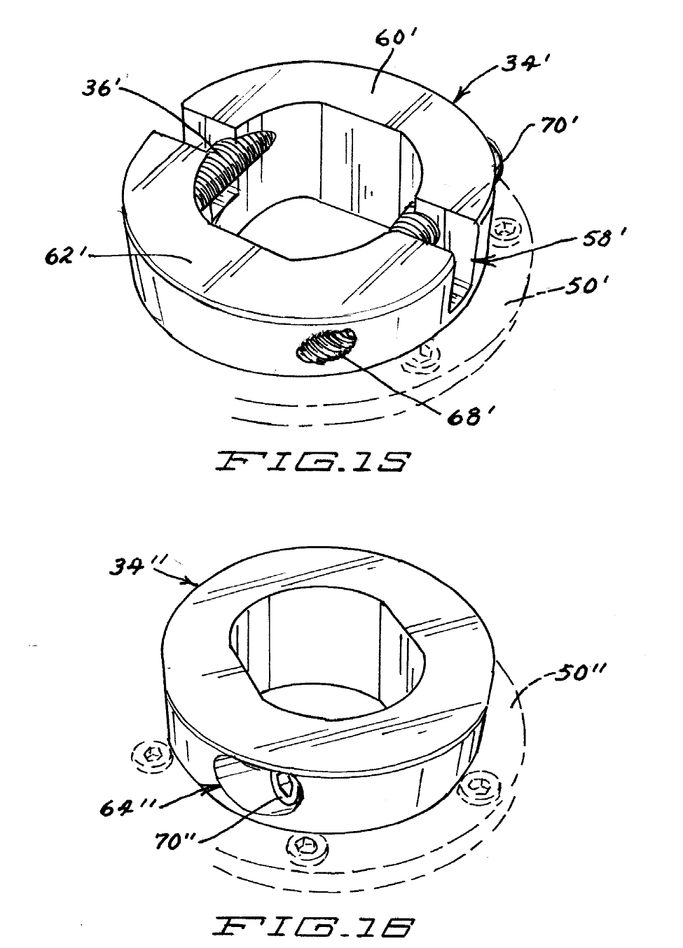

FIG. 15 discloses an alternative hub 34′. In this design, collar 54′ no longer has one split 58′ but two splits 58′ so that collar halves 60′ and 62′ are completely separate from one another. Collar half 60′ is still fixed to mounting ring 50′, but the movable half 62′ of collar 54 can be completely removed therefrom. In addition, a second fastener receiving passageway 64′ is provided in collar 54′ as two fasteners 36′ will be needed to tighten collar halves 60′ and 62′ together. The two passageways 64′ are on the opposite sides of collar 54′ displaced by 90° from flats 56′. Each passageway 64′ will be aligned with one relief 48 in the sleeve 32.

In using this hub design, the operator when inserting or dropping aftermarket steering wheel system 16 down onto sleeve 32 will do so without the separable collar half 62′ in place. Only fixed collar half 60′ will telescope down over sleeve 32 as system 16 is lowered. After the collar half 60′ has been so telescoped, the operator will move the other collar half 62′ into place from the side until the various portions 66′ and 68′ of the passageways 64′ in the two collar halves are aligned. Two fasteners 36′ will then be inserted through passageways 64′ and through the reliefs 48 in sleeve 32 and tightened in place. This will draw the movable collar half 62′ towards the fixed collar half 60′ until hub 34 is firmly clamped against sleeve 32.

Yet another hub design 34″ is shown in FIG. 16. In this design, hub 34″ is an integral one-piece member that is formed as part of or integral to mounting ring 50″ . A single fastener passageway 64″ is provided that is a blind or dead end hole with the far end of passageway 64″ in FIG. 16, i.e. the end that cannot be seen in FIG. 16, carrying the internal threads for fastener 36. Such a design is somewhat simpler, but will have somewhat more play than the clamping hub designs of the partially split or fully split collars 34 and 34′, respectively, described earlier herein.

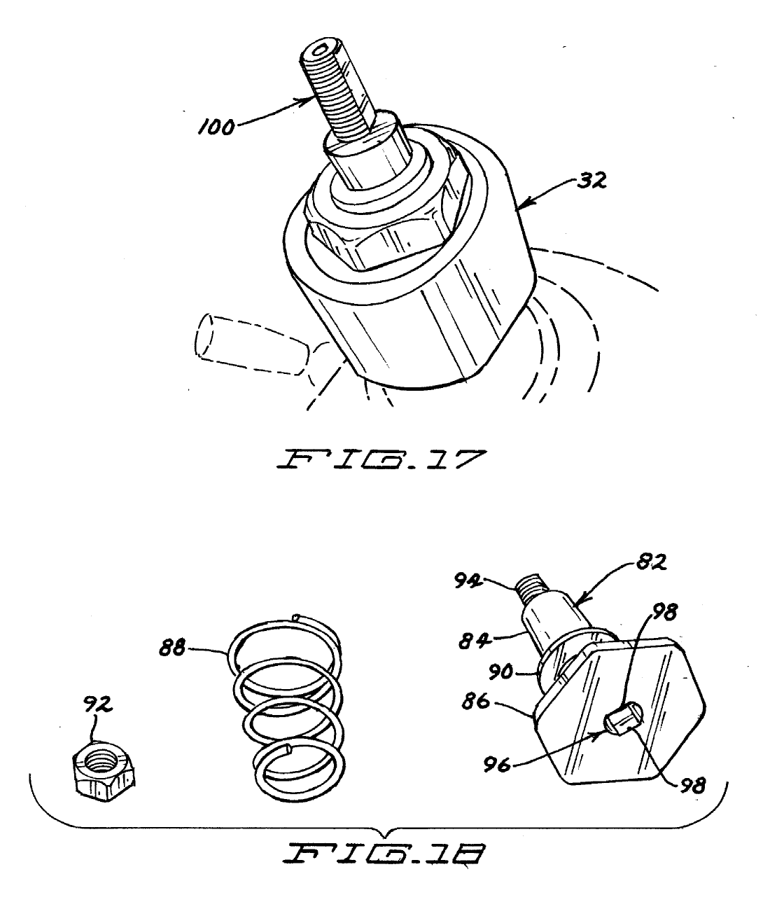

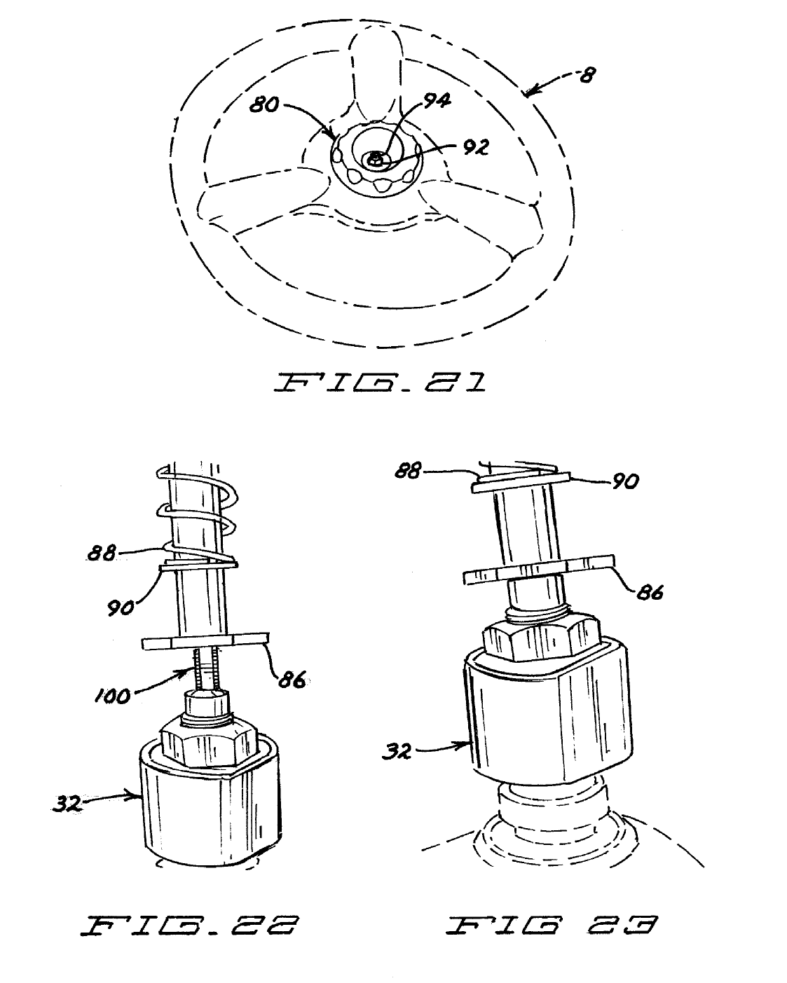

Turning now to FIGS. 17-24, some agricultural implements have steering shafts that telescope within the steering column to allow the operator to adjust the vertical height of steering wheel 8. Such telescopic extension systems typically have a rotary knob 80 that is selectively turned by a quarter turn or so in one direction to unlock the telescopic extension system for use. Knob 80 is shown in FIGS. 20 and 21 atop steering wheel 8. Turning knob 80 in one direction the required amount rotates a control shaft 100 about its axis to unlock the telescopic extension system, the control shaft 100 being concentrically received within steering shaft 10 but having an upper end extending upwardly beyond the upper end of steering shaft 10. Once the telescopic extension system is unlocked, the user can pull up on steering wheel 8 to lengthen steering shaft 10, or can push down on steering wheel 8 to shorten steering shaft 10, to thereby raise or lower steering wheel 8 according to the operator's preference. Once the operator has steering wheel 8 vertically positioned where he or she wants it, then knob 80 is turned back in the opposite direction by the operator to relock the telescopic extension system to thereby maintain the chosen position for steering wheel 8.

In accomplishing this function, knob 80 in known telescopic extension systems on the market must be secured to control shaft 100 so that manipulation of control shaft 100 by knob 80 both locks and unlocks the telescopic extension system. Typically, in such known systems, the upper end of the control shaft 100 is simply bolted to or screwed into knob 80. When an aftermarket steering wheel system 16 is used between steering wheel 8 and steering shaft 10 on an implement having a telescopic extension system for the steering shaft, the supplier of aftermarket steering wheel system 16 will include an extension rod having one end that bolts to or screws onto the upper end of control shaft 100 and another end that bolts to or screws into knob 80. This extension rod accommodates the difference in height in much the same way as extension cylinder 74. However, the extension rod when used still has a bolt or screw thread connection to control shaft 100.

This poses a problem if one attempts to use the quick connect system of this invention on the steering shaft 10 of an implement having a telescopic extension system for steering wheel 8. The presence of the extension rod and its bolt or screw thread connection to control shaft 100 interferes with the quick connect feature of this invention. One first has to access the connection between the extension rod and the control shaft to unscrew the extension rod in order for hub 34 to be released from sleeve 32. In order to address this issue, the Applicant herein has further invented a quick connect extender 82 that forms an optional portion of the quick connect system of this invention when one is installing the quick connect system on an implement with a telescopic extension system for steering shaft 10. This allows the functionality of the telescopic extension system to be retained.

Referring now to FIG. 18, the optional quick connect extender 82, has three parts, i.e. a T-shaped member having a vertical stem 84 with a horizontal bottom flange 86 at the lower end thereof, a spring 88 sized to fit around stem 84 with spring 88 bearing between the underside of steering wheel 8 and a circular washer 90 fixed on stem 84, and a nut 92 for being engaged on a threaded upper end 94 of stem 84. Bottom flange 86 has a non-circular bore 96, i.e. a bore 96 with two flats 98, which is shaped to fit onto the non-circular cross-sectional shape of the upper end of control shaft 100 shown in FIG. 17. The mating shapes between bore 96 and the upper end of control shaft 100 form a quick connection of their own that allows flange 86 to be slipped onto and pulled off of the upper end of control shaft 100 without the need for any screwing or unscrewing. However, because bore 96 and the mating upper end of control shaft 100 have mating non-circular cross-sectional shapes, rotation of stem 84 will be transmitted to the upper end of control shaft 100 to rotatably connect the two together.

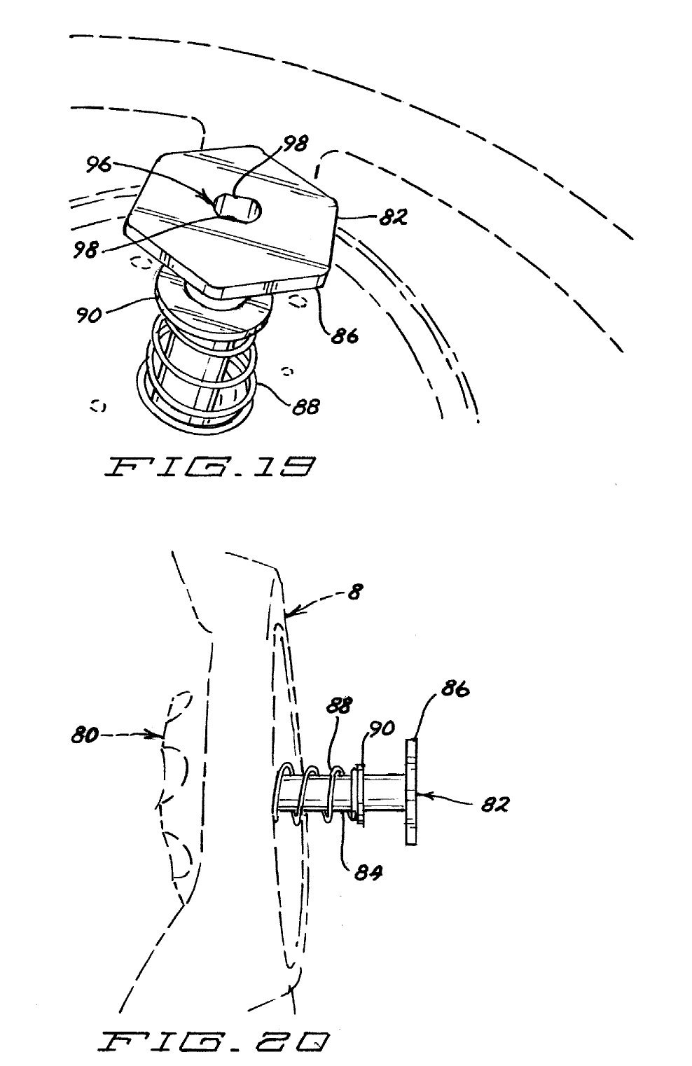

Quick connect extender 82 is installed on the underside of steering wheel 8 with stem 84 passing upwardly through the central bore of steering wheel 8 and a central bore of knob 80. When installed, the threaded upper end 94 of stem 84 will be located within a central recess in knob 80 so that nut 92 may be threaded onto upper end 94 of stem 84 to affix quick connect extender 82 to steering wheel 8. See FIG. 21. When so affixed and as shown in FIGS. 19 and 20, spring 88 puts downward force on fixed washer 90 to bias bottom flange 86 downwardly towards and into engagement with the upper end of control shaft 100. When so installed, quick connect extender 83 will normally be hidden within a central interior cavity in auto-steer motor 18 as shown in FIG. 24, bottom flange 86 normally being recessed about half of the way into the interior cavity of auto-steer motor 18. The quick connect system comprising sleeve 32 and hub 34 will be installed on the upper end of steering shaft 32 and on auto-steer motor 18 as described earlier herein and will function in the same way as described earlier herein. FIGS. 19, 20, 22 and 23 illustrate quick connect extender 83 with auto-steer motor 18 and hub 34 having been removed for the purpose of clarity.

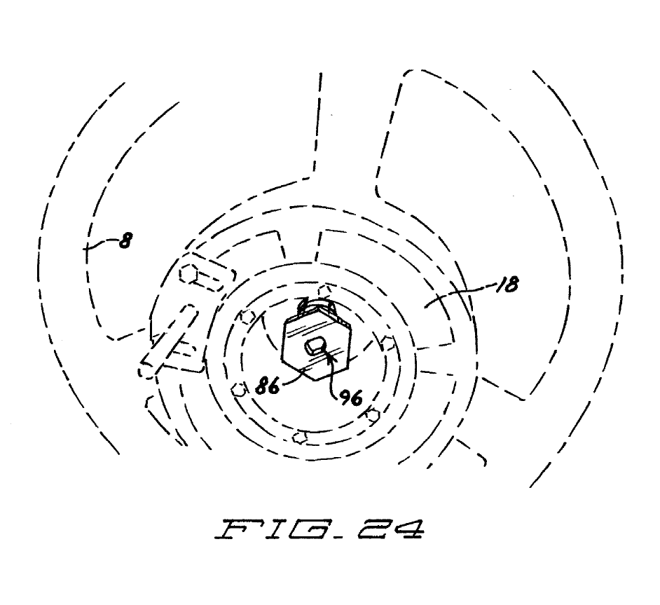

Referring now to FIGS. 22 and 23, quick connect extender 83, forming as it does its own separate quick connection to the upper end of control shaft 100, allows the hub 34 to be slipped down onto sleeve 32 in the normal manner, even though the implement has a telescopic extension system for steering shaft 10 that is unlocked and relocked by the manipulation of knob 80 to rotate control shaft 100 in one direction or the other. This is because the bottom flange 86 on stem 84 of quick connect extender 82 slips down onto the upper end of control shaft 100 in a quick connect fashion in the same manner as hub 34 slips down onto sleeve 32. FIG. 22 shows bottom flange 86 at the initial phase of being inserted onto the upper end of control shaft 100 while FIG. 23 shows bottom flange 86 at the end of its insertion onto control shaft 100. The same type of quick connection, i.e. a non-circular bore with two flats and two circular portions, is used both on hub 34 and on flange 86 of quick connect extender 82. Quick connect extender 82 shown herein allows sleeve 32 and hub 34 to be used on many additional implements, i.e. implements having telescopic extension systems for control shaft 100, in addition to implements which do not have such telescopic extension systems. For this latter class of implements not having telescopic extension systems for steering shafts 10, quick connect extender 82 is not needed and is not used.

Various modifications of this invention will be apparent to those skilled in the art. For example, the splined sections between sleeve 32 and the upper end of steering shaft 10 could be replaced by a key fitting into a keyway, or by mating non-circular shapes, depending on the configuration of the upper end of steering shaft 10. The two flat configuration between sleeve 32 and hub 34 could be replaced with other non-circular shapes, e.g. by a hex head configuration, though the two flat configuration is somewhat simpler to drop into place when sleeve 32 and hub 34 are being concentrically assembled. The use of a simple bolt as fastener 36 could be replaced with a spring loaded pin that could permit removal without the need for tools. For example, the spring load on the pin could keep an enlarged middle section on the pin engaged with the relief on sleeve 32. When the operator grabs an accessible head on the pin and pulls against the spring bias, a reduced diameter section of the pin will be positioned in the relief to clear the relief and to allow hub 34 to be pulled off sleeve 32. If a one fastener 36 design is used instead of the use of two fasteners 36, only one relief 48 would be necessary in sleeve 32, though the use of two reliefs 48 gives more flexibility in installation as alignment with fastener passageway 64 is somewhat easier.

Thus, this invention is not limited to the details of the various embodiments described herein.

1. A quick connect system for attaching a steering wheel system comprising a rotatable steering wheel positioned atop an auto-steer motor to a rotatable steering shaft of an agricultural vehicle, the auto-steer motor having a rotatable output member that is rotated when the auto-steer motor is activated by a control system in accordance with geographical positioning of the vehicle, which comprises:
(a) a sleeve having a central bore that is concentrically and non-rotatably received on an upper end of the steering shaft such that rotation of the sleeve is effective to rotate the steering shaft, the sleeve having at least one groove or relief provided on at least one side thereof;
(b) a hub having a central bore that is concentrically and non-rotatably received on the sleeve when the sleeve is non-rotatably received on the upper end of the steering shaft, the hub having at least one fastener passageway in at least one side thereof that is aligned with the at least one groove or relief in the sleeve when the hub is received on the sleeve, the hub being rigidly and releasably affixed to the output member of the auto-steer motor such that rotation of the output member rotates the hub when the auto-steer motor is activated, rotation of the hub in turn rotates the sleeve, and rotation of the sleeve in turn rotates the steering shaft; and
(c) an elongated fastener passing through the at least one fastener passageway in the hub and through the at least one groove or relief in the sleeve to secure the hub to the sleeve in a quick connect manner by installation of the fastener.

2. The system of claim 1, wherein the steering wheel system comprises an aftermarket steering wheel system that includes an aftermarket steering wheel and auto-steer motor that is sold as a unit and that is used to replace an OEM steering wheel originally provided on the steering shaft of the agricultural vehicle.

3. The system of claim 1, wherein the central bore of the sleeve and the upper end of the steering shaft have a mating non-rotational interface therebetween which permits axial motion of the sleeve over the upper end of the steering shaft when the sleeve is concentrically placed on the upper end of the steering shaft but does not permit rotary motion between the sleeve and the upper end of the steering shaft when the sleeve is received on the upper end of the steering shaft.

4. The system of claim 3, wherein the mating non-rotational interface between the sleeve and the upper end of the steering shaft comprises a splined interface.

5. The system of claim 4, wherein the upper end of the steering shaft has a threaded tip portion above the splined interface that threadedly receives an attachment nut for securing the sleeve to the upper end of the steering shaft.

6. The system of claim 3, wherein the central bore of the hub and the outer periphery of the steering shaft have a mating non-rotational interface therebetween which permits axial motion of the hub over the sleeve when the hub is concentrically placed on the sleeve but does not permit rotary motion between the hub and the sleeve when the hub is received on the sleeve.

7. The system of claim 6, wherein the mating non-rotational interface between the hub and the sleeve comprises a generally cylindrical interface having at least one flat thereon, and wherein the at least one groove or relief in the sleeve and the at least one fastener passageway in the hub are provided on sides of the sleeve and the hub that do not have the at least one flat of the interface with the at least one fastener passageway automatically being aligned with the at least one groove or relief in the sleeve when the hub is received on the sleeve with the respective flats thereon being mated with another.

8. The system of claim 7, wherein the mating non-rotational interface between the hub and the sleeve comprises two flats thereon disposed on opposite sides of the hub and the sleeve, wherein the at least one groove or relief in the sleeve comprises a pair of grooves or reliefs provided on opposite sides of the sleeve but being displaced by 90° from the flats, and wherein the at least one fastener passageway in the hub is on one side of the hub displaced by 90° from the flats.

9. The system of claim 8, wherein the hub comprises a collar having at least one split such that one portion of the collar is movable towards another fixed portion of the collar in a clamping fashion, and wherein the at least one fastener passageway in the hub bridges the split in the collar such that installation of the fastener in the at least one fastener passageway serves to move the collar portions towards one another.

10. The system of claim 9, wherein the fixed portion of the collar is rigidly secured to a ring that is rigidly affixed to the output member of the auto-steer member, the movable portion of the collar being separated from the ring to permit movement of the movable portion of the collar towards the fixed portion of the collar.

11. The system of claim 1, wherein the hub includes a plurality of bolt holes spaced in a pattern that matches a pattern of at least some bolt holes provided in the output member of the auto-steer member to allow the hub to be rigidly affixed to the output member of the auto-steer member by a plurality of bolts.

12. The system of claim 11, wherein the plurality of bolt holes in the hub are provided in an annular mounting ring portion of a collar, the collar having the central bore.

13. The system of claim 12, wherein the collar has at least one split such that one portion of the collar is movable towards another fixed portion of the collar.

14. The system of claim 11, further including an extension member having a first end that bolts to the bolt holes in the hub and a second end having a bolt hole pattern that matches at least some bolt holes provided in a steering wheel of a steering wheel system that lacks the auto-steer motor to allow the second end of the extension member to be bolted directly to the steering wheel to maintain the steering wheel's vertical position even when the auto-steer motor is absent from the auto-steer system.

15. The system of claim 1, wherein the steering wheel system includes a rotary knob atop the steering wheel for locking and unlocking a telescoping structure of the steering wheel system that allows a vertical position of the steering wheel to be adjusted, the rotary knob normally being attached to a control shaft for rotating the control shaft in a first direction to lock the telescoping structure and in a second direction to unlock the telescoping structure, and further including a quick connect extender placed between the knob and the control shaft and having a mating, non-rotational interface with the control shaft to permit the usual functionality of the knob and the control shaft when the quick connect system is used to connect a steering wheel system of the type having the telescoping structure and the knob and control shaft for locking and unlocking the telescoping structure.

16. The system of claim 15, wherein the quick connect extender comprises:
(a) a generally T-shaped member having a vertical stem with a horizontal bottom flange;
(b) a spring bearing between an underside of the steering wheel and an upwardly facing thrust surface of the stem;
(c) the stem being long enough to extend upwardly through a hub of the steering wheel and through the rotary knob such that a threaded upper end of the stem receives a nut that bears against a surface on the rotary knob to attach the quick connect extender to the steering wheel; and
(d) the non-rotational interface occurring between the bottom flange of the stem and the control shaft.

17. The system of claim 16, wherein the T-shaped member and spring are substantially housed within a central interior cavity of the auto-steer motor when the quick connect extender is used.

18. The system of claim 16, wherein the mating non-rotational interface is a non-circular bore in the bottom flange of the stem that mates with a non-circular cross-sectional shape of an upper end of the control shaft.

19. A quick connect system for a steering wheel system of a vehicle, which comprises:
(a) a sleeve concentrically received around a steering shaft of the vehicle and a hub concentrically received around and releasably secured to the sleeve by at least one fastener;
(b) mating non-rotary interfaces provided between the shaft and sleeve and the hub and the sleeve when the shaft, sleeve and hub are concentrically arranged relative to one another; and
(c) wherein the hub is releasably secured to a rotatable output member of an auto-steer motor of the steering wheel system.
